(19) United States
(12) Patent Application Publication
(10) Pub. No.: US 2025/0060273 A1
(43) Pub. Date: Feb. 20, 2025

(54) OFFLINE ITERATIVE REAL-TIME HYBRID TEST METHOD AND SYSTEM FOR SEISMIC ISOLATION STRUCTURE

(71) Applicant: GUANGZHOU UNIVERSITY, Guangzhou (CN)

(72) Inventors: Huimeng ZHOU, Guangzhou (CN); Ao XUN, Guangzhou (CN); Xusheng ZHENG, Guangzhou (CN); Ping TAN, Guangzhou (CN)

(73) Assignee: GUANGZHOU UNIVERSITY, Guangzhou (CN)

(21) Appl. No.: 18/807,828

(22) Filed: Aug. 16, 2024

(30) Foreign Application Priority Data
Aug. 18, 2023 (CN) 202311049318.4

(51) Int. Cl. G01M 7/00; G06F 17/11

(52) U.S. Cl. CPC G01M 7/00; G06F 17/11

(57) ABSTRACT

Present disclosure provides a test method and system for a seismic isolation structure, the method comprising: loading driving displacement time history signal into a substructure of the structure, recording restoring force time history feedback signal of the substructure; applying restoring force time history feedback signal to numerical substructure of seismic isolation structure, solving dynamic response of numerical substructure, recording structural displacement response time of the numerical substructure; calculating root-mean-square error (RMSE) of driving displacement time history signal and structural displacement response time signal; judging whether the RMSE is less than a threshold; if the RMSE is less than the threshold, ending the experiment; if the RMSE is not less than the threshold: correcting the time history signals according to a model identification algorithm, obtaining a corrected driving displacement time history signal of the next iteration, loading the corrected driving displacement time history signal onto the substructure, and repeating the steps.

### TECHNICAL FIELD

The present document relates to the technical field of structural anti-seismic performance assessment, and in particular to an offline iterative real-time hybrid test method and system for a seismic isolation structure.

### BACKGROUND

With the development of seismic isolation technology, velocity-dependent components such as a seismic isolation bearing have been widely used in actual engineering structures, and most of the structures adopting seismic isolation devices exhibit rate-dependent features, and seismic experiments put forward higher requirements in terms of the loading device and the loading rate, which require using a dynamic actuator for real-time loading of the structure. However, most of the time, conventional experiment loading conditions are not able to reproduce the true response of components under seismic actions.

In order to solve the limitations of the high requirements of real-time hybrid test communication platforms and loading equipment, a novel method for offline hybrid iterative test has emerged. The offline hybrid iterative tests, unlike the real-time hybrid test where a converge is calculated within each time step, uses an offline iterative complete time history to complete the hybrid experiment, i.e., the numerical computation and the experiment loading is performed independently throughout the seismic time period. The substructure displacement response or restoring force time history for the whole seismic time period is transferred between them. This method divides the numerical computation and the servo-loading experiment into two relatively independent parts with no data interaction in the intermediate time steps, therefore, an excellent numerical calculation method in pure numerical simulation can be used, and a time delay effect is no longer present.

Currently the offline hybrid iterative test is relatively rarely applied to large and complex structures, the large equipment was rarely utilized in the offline hybrid iterative test for loading experiment substructures. There are a number of challenges associated with real-time hybrid test for seismic isolation structures: i.e., due to the real-time hybrid experiment having real-time requirements, the real-time hybrid test requires not only real-time computation of the numerical substructure, but also real-time communication between the numerical computation and the experiment loading, which imposes high requirements on the communication platform and the loading equipment.

### SUMMARY

One or more embodiments of the present specification provide an offline iterative real-time hybrid experiment method for a seismic isolation structure, including:
S1, loading a driving displacement time history signal extracted from the seismic isolation structure onto an experiment substructure of the seismic isolation structure, and recording a restoring force time history feedback signal of the experiment substructure;
S2, applying the restoring force time history feedback signal to a numerical substructure of the seismic isolation structure, solving a dynamic response of the numerical substructure, and recording a structural displacement response time history signal of the numerical substructure;
S3, calculating a root-mean-square error value of the driving displacement time history signal and the structural displacement response time history signal; judging whether the root-mean-square error value is less than a preset threshold value; if the root-mean-square error value is less than the preset threshold value, then ending the test; if the root-mean-square error value is not less than the preset threshold value, then performing step S4;
S4, iteratively correcting the driving displacement time history signal and the structural displacement response time history signal according to the model identification algorithm, and obtaining a corrected driving displacement time history signal of the next iteration, loading the corrected driving displacement time history signal into the experiment substructure as recited in step S1, and repeating the above steps.

One or more embodiments of the present specification provide an offline iterative real-time hybrid test system for a seismic isolation structure, including:
the first calculation module: configured to load a driving displacement time history signal extracted from the seismic isolation structure onto an experiment substructure of the seismic isolation structure, and recording the restoring force time history feedback signal of the experiment substructure;
the second calculation module: configured to apply the restoring force time history feedback signal to a numerical substructure of the seismic isolation structure, solving the dynamic response of the numerical substructure, and record a structural displacement response time history signal of the numerical substructure;
a judgment module: configured to calculate a root-mean-square error value of the driving displacement time history signal and the structural displacement response time history signal, judge whether the root-mean-square error value is less than a preset threshold value; if the root-mean-square error value is less than the preset threshold value, then end the test; if the root-mean-square error value is not less than the preset threshold value, then correct the above time history signals according to a correction module;
a correction module: configured to iteratively correct the driving displacement time history signal and the structural displacement response time history signal according to the model identification algorithm, and obtain a corrected driving displacement time history signal of the next iteration, and loading the corrected driving displacement time history signal into the experiment substructure of the first calculation module.

One or more embodiments of the present specification provide electronic equipment, including:
a processor; and,
a memorizer, arranged to store computer executable instructions, which, when executed, causes the processor to implement the steps of the offline iterative real-time hybrid experiment method for a seismic isolation structure.

One or more embodiments of the present specification provide a storage medium, configured to store computer executable instructions, which, when executed, implements the steps of the offline iterative real-time hybrid test method for a seismic isolation structure.

Beneficial effects of the present disclosure are as follows:

The present disclosure can real-time load the seismic displacement time history into the experiment substructure, that is, a seismic isolation bearing with a large and complex structure. The present disclosure combines real-time loading with offline iterative correction, and can have an iterative correction effect on the signal error between the bearing and the structure, and has feasibility, effectiveness, robustness and practicability; this method reduces requirements on a communication platform and loading equipment, can simulate the seismic performance of a large and complex seismic isolation structure in the experiment laboratory, conduct a real-time hybrid test for a large-scale numerical substructure model with many degrees of freedom, and can also be applied to an anti-seismic performance experiment for a large and complex seismic isolation structure. It is not necessary for the present disclosure to simplify the numerical substructure model; and the present disclosure can independently perform experiment loading and numerical calculations during the entire earthquake action time period, without no data interaction during intermediate time, therefore, an excellent numerical calculation method in pure numerical simulation can be used, thus improving tracking accuracy and tracking efficiency.

The above description is only an overview of the technical solution of the present disclosure, and in order to be able to more clearly understand the technical means of the present disclosure, which may be implemented in accordance with the contents of the specification, and in order to make the above and other objects, features and advantages of the present disclosure more apparent and easy to understand, specific embodiments of the present disclosure are particularly cited hereinafter.

### BRIEF DESCRIPTION OF THE DRAWINGS

In order to more clearly illustrate the technical solutions in one or more embodiments of the present specification or prior art, the following will briefly introduce the accompanying drawings that need to be used in the description of the embodiments or prior art, and it will be apparent that the accompanying drawings in the following description are only some of the embodiments documented in the present specification, and that for the those skilled in the art, on the premise of no creative efforts, other accompanying drawings may be obtained according to these accompanying drawings.

FIG. 1 illustrates a flowchart of an offline iterative real-time hybrid test method for a seismic isolation structure provided in one or more embodiments of the present specification;

FIG. 2 illustrates a flowchart of a framework for an offline iterative real-time hybrid test method for seismic isolation structures of the present embodiment;

FIG. 3 shows a schematic diagram of an iterative correction process of a model identification algorithm of the present embodiment;

FIG. 4 illustrates a schematic diagram of an offline iterative real-time hybrid test system for a seismic isolation structure provided in one or more embodiments of the present specification;

FIG. 5 illustrates a structural schematic diagram of electronic equipment provided in one or more embodiments of the present specification.

### DETAILED DESCRIPTION

In order to enable those skilled in the art to better understand the technical solutions in the one or more embodiments of the present specification, the technical solutions in the one or more embodiments of the present specification will be clearly and completely described hereinafter in conjunction with the accompanying drawings in the one or more embodiments of the present specification. It is apparent that the described embodiments are only a part of embodiments in the present specification, but not all of the embodiments. Based on the one or more embodiments of the present specification, all other embodiments obtained by those skilled in the art without making creative efforts should fall within the protection scope of the present document.

### Method Embodiment

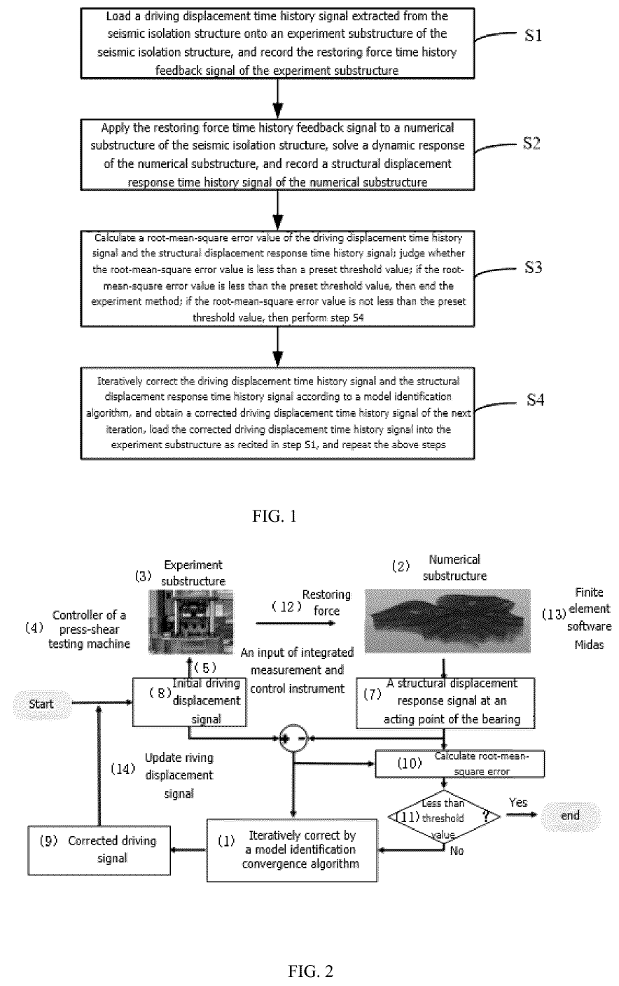

According to the embodiment of the present disclosure, an offline iterative real-time hybrid test method for a seismic isolation structure is provided, and FIG. 1 illustrates a flowchart of an offline iterative real-time hybrid test method for a seismic isolation structure provided in one or more embodiments of the present specification. As shown in FIG. 1, according to an embodiment of the present disclosure, the offline iterative real-time hybrid test method for the seismic isolation structure specifically includes:

S1, a driving displacement time history signal extracted from the seismic isolation structure is loaded into an experiment substructure of the seismic isolation structure, and the restoring force time history feedback signal of the experiment substructure is recorded.

Specifically, the driving displacement time history signal is transmitted to a press-shear testing machine by an integrated measurement and control instrument; the corrected driving displacement time history signal is loaded into the experiment substructure, by the press-shear testing machine, in a form of displacement control; and the restoring force time history feedback signal of the experiment substructure is recorded.

S2, the restoring force time history feedback signal is applied to a numerical substructure of the seismic isolation structure, a dynamic response of the numerical substructure is solved, and a structural displacement response time history signal of the numerical substructure is recorded.

The experiment substructure is any seismic isolation bearing of the seismic isolation structure, and the numerical substructure is a remaining portion, except for the any seismic isolation bearing, of the seismic isolation structure.

S3, a RMSE value of the driving displacement time history signal and the structural displacement response time history signal is calculated; whether the root-mean-square error value is less than a preset threshold value is judged; if the root-mean-square error value is less than the preset threshold value, then the experiment method is ended; if the root-mean-square error value is not less than the preset threshold value, then step S4 is performed.

S4, the driving displacement time history signal and the structural displacement response time history signal are iteratively corrected according to a model identification algorithm, and a corrected driving displacement time history signal of the next iteration is obtained, the corrected driving displacement time history signal is loaded into the experiment substructure as recited in step S1, and the above steps are repeated.

The step of iteratively correcting the driving displacement time history signal and the structural displacement response time history signal according to the model identification algorithm, and obtaining the corrected driving displacement time history signal of the next iteration, recited in the method, specifically includes:
according to a response error at a boundary intersection between the driving displacement time history signal of the experiment substructure and a structural displacement response time history signal of the numerical substructure, the response error between the above two substructures is converted into a correction value of the driving displacement time history signal according to an inverse frequency response function matrix;
a correction value of the driving displacement time history signal is substituted into the driving displacement time history signal in a current iteration for a correction, a new driving signal is generated, and it is updated to a new driving displacement time history signal of a next iteration.

FIG. 2 illustrates a flowchart of the framework of the offline iterative real-time hybrid test method for the seismic isolation structure of the present embodiment, as shown in FIG. 2:

At the beginning of the experiment, a displacement time history at a bearing of a simulated complete seismic isolation structure of the numerical substructure (2) is taken as the initial driving displacement time history signal (8); the initial driving displacement time history signal (8) is loaded into the experiment substructure (3) on the press-shear testing machine (4) by using the integrated measuring and control instrument (5); and after the loading is completed, the restoring force time history feedback signal (12) of the experiment substructure at the seismic isolation bearing is recorded; the restoring force time history feedback signal (12) is applied to the numerical substructure model (2); and its dynamic response is solved by a finite element software Midas (13); the structural displacement response time history signal (7) at an action point of the bearing is recorded; and the structural displacement response time history signal (7) (output) is compared with the driving displacement time history signal (8) (input); and then the root-mean-square error (10) for both signals is calculated, and it is compared with the threshold value (11); whether the root-mean-square error (10) is less than the threshold value (11) is calculated; if it is greater than the threshold value (11), then a corrected driving displacement time history signal of the next iteration (9) is iteratively corrected and obtained by the model identification algorithm (1); and a driving signal updating (14) is carried out by updating the corrected driving displacement time history signal of the next iteration (9); and it is loaded as a new driving displacement time history signal of the experiment substructure (8) (system input signal) onto the experiment substructure (3); and the above steps are performed in a repeated cycle, until the calculated root-mean-square error is less than the threshold value, and the experiment method ends.

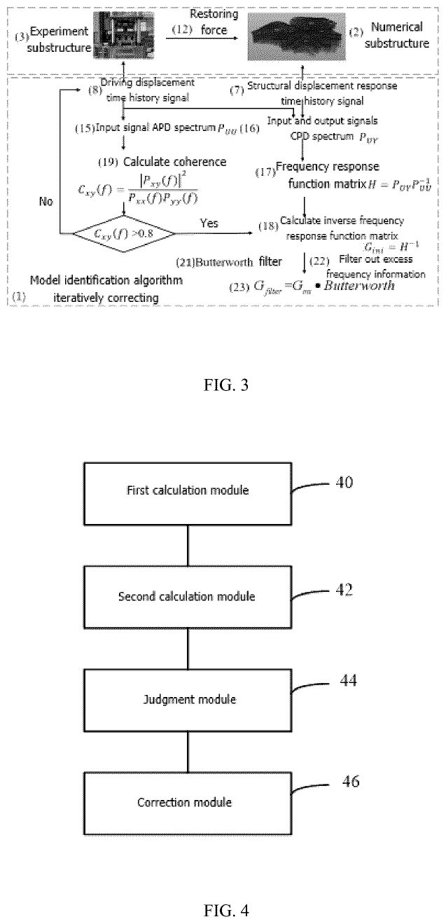

FIG. 3 illustrates a schematic diagram of an iterative correction process of a model identification algorithm. As shown in FIG. 3, a method of obtaining the corrected driving displacement time history signal of the next iteration by the iterative correction process of the model identification algorithm specifically includes:

The iterative correction according to the model identification algorithm (1) includes: a structural displacement response time history signal (7) of the numerical substructure (system output signal Y); a driving displacement time history signal (8) of the experiment substructure (system input signal U); an auto-power density (APD) spectrum P_{UU} (15) of a input signal and cross-power density (CPD) spectrum P_{UY} (16) of input and output signals are calculated and obtained according to U and Y, so as to obtain a frequency response function matrix H=P_{UY}P_{UU}⁻¹ (17); and, whether an inverse frequency response function matrix Gᵢₙᵢ=H⁻¹ (18) is valid is judged; whether a coherence is greater than 0.8 is judged by calculating an amplitude-squared coherence function

$${C}_{xy} = \frac{{\vert {P}_{xy} ( f ) \vert}^{2}}{{P}_{xx} ( f ) {P}_{yy} ( f )}$$

(19) between the input signal and the output signal; if the above judgment requirement is not satisfied, then the calculation is re-substituted; and if the above judgment requirement is satisfied, then excess frequency information (22) in an uninterested frequency range of an inverse frequency response function matrix Gᵢₙᵢ=H⁻¹ (18) is filtered out by using a Butterworth filter (21), so as to obtain the inverse frequency response function matrix G filter (23) obtained in the model identification algorithm. In each iteration, according to the response error (10) between the experimental substructure (3) and the numerical substructure (2) at the boundary intersection, the response error (10) between the two substructures is converted into the correction amount of the driving displacement time history signal by using the inverse frequency response function matrix (18); and, the correction value of the driving displacement time history signal is substituted into the driving displacement time history signal in a current iteration for a correction, and a new driving signal (9) is generated, and it is updated to a new driving displacement time history signal of a next iteration (8), and the whole algorithmic process ends in MATLAB and Simulink programs.

The present disclosure is further described hereinafter in connection with specific embodiments:

Three seismic waves used in designing a seismic isolation structure of a terminal building of a large airport are selected as ground motion conditions for the offline hybrid iterative test for this seismic isolation structure. A certain isolation bearing of the terminal building is treated as an experiment substructure, and a remaining portion of the seismic isolation structure of the terminal building is treated as a numerical substructure.

A displacement time history at this bearing is extracted from a Midas model of the complete seismic isolation structure as an initial driving displacement time history signal. A process of an offline iterative real-time hybrid test system for the seismic isolation structure is as follows:

A displacement time history at the bearing under a certain seismic wave condition is extracted from the Midas model of the complete seismic isolation structure of the terminal building as an initial driving displacement time history signal. The initial driving displacement time history signal is transmitted to a controller of the press-shear testing machine by using an integrated measuring and control instrument; and the signal is loaded into the experiment substructure by the press-shear testing machine in the form of displacement control; and the restoring force time history feedback signal of the experiment substructure is recorded;
the restoring force time history is applied to the Midas model of the numerical substructure, the dynamic response is solved by inputting a certain seismic wave, and the structural displacement response time history signal is recorded;
the driving displacement time history signal is compared with the structural displacement response time history signal, a root-mean-square error of the driving displacement time history signal and the structural displacement response time history signal is calculated, and then whether the root-mean-square error is less than a threshold value is judged;
whether the root-mean-square error is less than a threshold value is calculated; and if the root-mean-square error is greater than the threshold value, then a corrected driving displacement time history signal is iteratively corrected and obtained by the model identification algorithm, and the driving signal, that is, the corrected driving displacement time history signal of a next iteration, is updated, and it is loaded as a new driving displacement time history signal of the experiment substructure (the system input signal) into the experiment substructure, and the above steps are performed in a repeated cycle, until the calculated root-mean-square error is less than the threshold value, and the experiment method ends.

Beneficial effects of the present disclosure are as follows:

The present disclosure can real-time load the seismic displacement time history into the experiment substructure, that is, a seismic isolation bearing with a large and complex structure. The present disclosure combines real-time loading with offline iterative correction, and can have an iterative correction effect on the signal error between the bearing and the structure, and has feasibility, effectiveness, robustness and practicability; this method reduces requirements on a communication platform and loading equipment, can simulate the seismic performance of a large and complex seismic isolation structure in the experiment laboratory, conduct a real-time hybrid test for a large-scale numerical substructure model with many degrees of freedom, and can also be applied to an anti-seismic performance experiment for a large and complex seismic isolation structure. It is not necessary for the present disclosure to simplify the numerical substructure model; and the present disclosure can independently perform experiment loading and numerical calculations during the entire earthquake action time period, without no data interaction during intermediate time, therefore, an excellent numerical calculation method in pure numerical simulation can be used, thus improving tracking accuracy and tracking efficiency.

### System Embodiment

According to the embodiment of the present disclosure, an offline iterative real-time hybrid test system for a seismic isolation structure is provided, and FIG. 4 illustrates a schematic diagram of an offline iterative real-time hybrid test system for a seismic isolation structure provided in one or more embodiments of the present specification. As shown in FIG. 4, the offline iterative real-time hybrid test system for the seismic isolation structure according to the embodiment of the present disclosure specifically includes:
a first calculation module 40: configured to load a driving displacement time history signal extracted from the seismic isolation structure onto an experiment substructure of the seismic isolation structure, and record the restoring force time history feedback signal of the experiment substructure;
where the first calculation module 40 is specifically configured to:
transmit the driving displacement time history signal to a controller of a press-shear testing machine by an integrated measurement and control instrument; load the corrected driving displacement time history signal onto the experiment substructure by the press-shear testing machine, in a form of displacement control; and record the restoring force time history feedback signal of the experiment substructure;
a second calculation module 42: configured to apply the restoring force time history feedback signal onto a numerical substructure of the seismic isolation structure, solve a dynamic response of the numerical substructure, and record a structural displacement response time history signal of the numerical substructure;
where the experiment substructure is any seismic isolation bearing of the seismic isolation structure, and the numerical substructure is a remaining portion, except for the any seismic isolation bearing, of the seismic isolation structure;
a judgment module 44: configured to calculate a root-mean-square error value of the driving displacement time history signal and the structural displacement response time history signal, according to the driving displacement time history signal and the structural displacement response time history signal; judge whether the root-mean-square error value is less than a preset threshold value; if the root-mean-square error value is less than the preset threshold value, then end the experiment method; if the root-mean-square error value is not less than the preset threshold value, then correct the above time history signals according to a correction module;
the correction module 46: configured to iteratively correcting the driving displacement time history signal and the structural displacement response time history signal, according to a model identification algorithm, and obtaining a corrected driving displacement time history signal of the next iteration, and load the corrected driving displacement time history signal onto the experiment substructure of the first calculation module;
where the correction module 46 is specifically configured to:
according to a response error at a boundary intersection between the driving displacement time history signal of the experiment substructure and a structural displacement response time history signal of the numerical substructure, convert the response error between the above two substructures into a correction value of the driving displacement time history signal according to an inverse frequency response function matrix;
substitute a correction value of the driving displacement time history signal into the driving displacement time history signal in a current iteration for a correction, generate a new driving signal, and update it to a new driving displacement time history signal of a next iteration.

The embodiment of the present disclosure is a system embodiment corresponding to the above method embodiment. Specific operations of each module can be understood with reference to the description of the method embodiment, and will not be described redundantly herein.

### Device Embodiment I

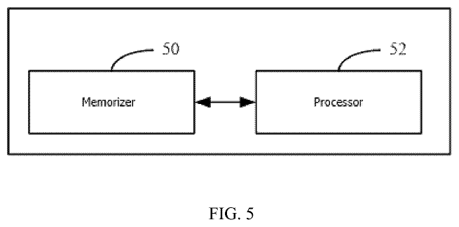

The embodiment of the present disclosure provides electronic equipment, as shown in FIG. 5, including: a memorizer 50, a processor 52, and a computer program stored on the memorizer 50 and executable on the processor 52. The computer program, when executed by the processor 52, implements the following method steps:
S1, a driving displacement time history signal extracted from the seismic isolation structure is loaded into an experiment substructure of the seismic isolation structure, and the restoring force time history feedback signal of the experiment substructure is recorded;
S2, the restoring force time history feedback signal is applied to a numerical substructure of the seismic isolation structure, a dynamic response of the numerical substructure is solved, and a structural displacement response time history signal of the numerical substructure is recorded;
S3, a root-mean-square error value of the driving displacement time history signal and the structural displacement response time history signal is calculated according to the driving displacement time history signal and the structural displacement response time history signal; whether the root-mean-square error value is less than a preset threshold value is judged; if the root-mean-square error value is less than the preset threshold value, then the experiment method ends; if the root-mean-square error value is not less than the preset threshold value, then step S4 is performed;
S4, the driving displacement time history signal and the structural displacement response time history signal is iteratively corrected according to a model identification algorithm, and a corrected driving displacement time history signal of the next iteration is obtained, the corrected driving displacement time history signal is loaded into the experiment substructure as recited in step S1, and the above steps are repeated.

### Device Embodiment II

The embodiment of the present disclosure provides a computer readable storage medium, on which, a program for implementing information transmission is stored, where the program, when executed by the processor 52, implements the following method steps:
S1, a driving displacement time history signal extracted from the seismic isolation structure is loaded into an experiment substructure of the seismic isolation structure, and the restoring force time history feedback signal of the experiment substructure is recorded;
S2, the restoring force time history feedback signal is applied to a numerical substructure of the seismic isolation structure, a dynamic response of the numerical substructure is solved, and a structural displacement response time history signal of the numerical substructure is recorded;
S3, a root-mean-square error value of the driving displacement time history signal and the structural displacement response time history signal is calculated according to the driving displacement time history signal and the structural displacement response time history signal; whether the root-mean-square error value is less than a preset threshold value is judged; if the root-mean-square error value is less than the preset threshold value, then the experiment method ends; if the root-mean-square error value is not less than the preset threshold value, then step S4 is performed;
S4, the driving displacement time history signal and the structural displacement response time history signal is iteratively corrected according to a model identification algorithm, and a corrected driving displacement time history signal of the next iteration is obtained, the corrected driving displacement time history signal is loaded into the experiment substructure as recited in step S1, and the above steps are repeated.

The computer-readable storage medium described in this embodiment includes, but is not limited to, ROM, RAM, magnetic disk, optical disk, or the like.

Finally, it should be noted that the above embodiments are only used to illustrate, rather than limiting the technical solutions of the present disclosure. Although the present disclosure has been described in detail with reference to the foregoing embodiments, those skilled in the art should understand that the technical solutions described in the foregoing embodiments can still be modified, or some or all of the technical features can be equivalently substituted; and these modifications or substitutions do not deviate the essence of the corresponding technical solutions from a scope of the technical solutions of the embodiments of the present disclosure.

1. An offline iterative real-time hybrid test method for a seismic isolation structure, comprising:
S1, loading a driving displacement time history signal extracted from the seismic isolation structure onto an experiment substructure of the seismic isolation structure, and recording the restoring force time history feedback signal of the experiment substructure;
S2, applying the restoring force time history feedback signal to a numerical substructure of the seismic isolation structure, solving a dynamic response of the numerical substructure, and recording a structural displacement response time history signal of the numerical substructure;
S3, calculating a root-mean-square error value of the driving displacement time history signal and the structural displacement response time history signal; judging whether the root-mean-square error value is less than a preset threshold value; if the root-mean-square error value is less than the preset threshold value, then ending the experiment method; if the root-mean-square error value is not less than the preset threshold value, then performing step S4;
S4, iteratively correcting the driving displacement time history signal and the structural displacement response time history signal according to a model identification algorithm, and obtaining a corrected driving displacement time history signal of the next iteration, loading the corrected driving displacement time history signal into the experiment substructure as recited in step S1, and repeating the above steps.

2. The method according to claim 1, wherein the experiment substructure is any seismic isolation bearing of the seismic isolation structure, and the numerical substructure is a remaining portion, except for the any seismic isolation bearing, of the seismic isolation structure.

3. The method according to claim 2, wherein step S1 recited in the method specifically comprises:
transmitting the driving displacement time history signal to a controller of a press-shear testing machine by an integrated measurement and control instrument; loading the corrected driving displacement time history signal onto the experiment substructure by the press-shear testing machine in a form of displacement control; and recording the restoring force time history feedback signal of the experiment substructure.

4. The method according to claim 1, wherein the iteratively correcting the driving displacement time history signal and the structural displacement response time history signal according to the model identification algorithm, and obtaining the corrected driving displacement time history signal of the next iteration, recited in the method specifically comprises:
according to a response error at a boundary intersection between the driving displacement time history signal of the experiment substructure and a structural displacement response time history signal of the numerical substructure, converting the response error between the above two substructures into a correction value of the driving displacement time history signal according to an inverse frequency response function matrix;
substituting a correction value of the driving displacement time history signal into the driving displacement time history signal in a current iteration for a correction, generating a new driving signal, and updating it into a new driving displacement time history signal of a next iteration.

5. An offline iterative real-time hybrid test system for a seismic isolation structure, comprising:
a first calculation module: configured to load a driving displacement time history signal extracted from the seismic isolation structure onto an experiment substructure of the seismic isolation structure, and record the restoring force time history feedback signal of the experiment substructure;
a second calculation module: configured to apply the restoring force time history feedback signal to a numerical substructure of the seismic isolation structure, solve a dynamic response of the numerical substructure, and record a structural displacement response time history signal of the numerical substructure;
a judgment module: configured to calculate a root-mean-square error value of the driving displacement time history signal and the structural displacement response time history signal; judge whether the root-mean-square error value is less than a preset threshold value; if the root-mean-square error value is less than the preset threshold value, then end the experiment method; if the root-mean-square error value is not less than the preset threshold value, then correct the above time history signals according to a correction module;
a correction module: configured to iteratively correct the driving displacement time history signal and the structural displacement response time history signal according to a model identification algorithm, and obtain a corrected driving displacement time history signal of the next iteration, and load the corrected driving displacement time history signal into the experiment substructure of the first calculation module.

6. The system according to claim 5, wherein the experiment substructure is any seismic isolation bearing of the seismic isolation structure, and the numerical substructure is a remaining portion, except for the any seismic isolation bearing, of the seismic isolation structure.

7. The system according to claim 5, wherein the first calculation module is specifically configured to
transmit the driving displacement time history signal to a controller of press-shear testing machine by an integrated measurement and control instrument; load the corrected driving displacement time history signal onto the experiment substructure by the press-shear testing machine in a form of displacement control; and record the restoring force time history feedback signal of the experiment substructure.

8. The system according to claim 5, where the correction module is specifically configured to.
according to a response error at a boundary intersection between the driving displacement time history signal of the experiment substructure and a structural displacement response time history signal of the numerical substructure, convert the response error between the above two substructures into a correction value of the driving displacement time history signal according to an inverse frequency response function matrix;
substitute a correction value of the driving displacement time history signal into the driving displacement time history signal in a current iteration for a correction, generate a new driving signal, and update it into a new driving displacement time history signal of a next iteration.

9. Electronic equipment, comprising:
a processor; and
a memorizer, arranged to store computer executable instructions, which, when executed, causes the processor to implement the offline iterative real-time hybrid test method for the seismic isolation structure according to claim 1.

10. A storage medium, configured to store computer executable instructions, the computer executable instructions, which, when executed, implements the offline iterative real-time hybrid test method for the seismic isolation structure according to claim 1.

11. Electronic equipment, comprising:
a processor; and
a memorizer, arranged to store computer executable instructions, which, when executed, causes the processor to implement the offline iterative real-time hybrid test method for the seismic isolation structure according to claim 2.

12. Electronic equipment, comprising:
a processor; and
a memorizer, arranged to store computer executable instructions, which, when executed, causes the processor to implement the offline iterative real-time hybrid test method for the seismic isolation structure according to claim 3.

13. Electronic equipment, comprising:
a processor; and
a memorizer, arranged to store computer executable instructions, which, when executed, causes the processor to implement the offline iterative real-time hybrid test method for the seismic isolation structure according to claim 4.

14. A storage medium, configured to store computer executable instructions, the computer executable instructions, which, when executed, implements the offline iterative real-time hybrid test method for the seismic isolation structure according to claim 2.

15. A storage medium, configured to store computer executable instructions, the computer executable instructions, which, when executed, implements the offline iterative real-time hybrid test method for the seismic isolation structure according to claim 3.

16. A storage medium, configured to store computer executable instructions, the computer executable instructions, which, when executed, implements the offline iterative real-time hybrid test method for the seismic isolation structure according to claim 4.
